(19) United States
(12) Patent Application Publication
(10) Pub. No.: US 2005/0101343 A1
(43) Pub. Date: May 12, 2005

(54) Mobile phone device with video output

(76) Inventor: Shih-Shien Hsiao, Shenkeng Township (TW)

Correspondence Address: J.C. Patents, Inc., Suite 250, 4 Venture, Irvine, CA, 92618, US

(21) Appl. No.: 10/712,245

(22) Filed: Nov. 12, 2003

(51) Int. Cl. H04B 1/38

(52) U.S. Cl. 455/550.1; 455/566

(57) ABSTRACT

A mobile phone device with video output function is provided. Digital images captured by a digital camera module within the mobile phone device or digital images stored within a memory card are converted to analogue video signals through a video digital/analogue converter. The analogue video signals are subsequently transmitted to a screen projector or a television set for display.

### BACKGROUND OF THE INVENTION

1. Field of the Invention

The present invention relates to a mobile phone device. More particularly, the present invention relates to a mobile phone device with a video output function.

2. Description of the Related Art

As our communication network advances, the amount of communication between people using various types of equipment increases tremendously. In recent years, the rapid pace in which electronic devices are developed has created various mobile communication systems such as the GSM, the CDMA and the 3G so that an unprecedented number of users are tapped into the communication network through mobile phone devices.

To enhance the features of a portability mobile phone devices, additional functions are frequently incorporated such as the merger with a digital camera. However, the images captured by the digital camera are either stored within a memory card or transmitted to other devices through a wireless transmission. Without a video output terminal for displaying the images, usefulness of the digital camera function on the mobile phone device is limited.

### SUMMARY OF THE INVENTION

Accordingly, one objective of the present invention is to provide a mobile phone device with a video output function so that digital images captured by the phone or stored within a memory card can be displayed by transmitting to a screen projector or a television set.

To achieve these and other advantages and in accordance with the purpose of the invention, as embodied and broadly described herein, the invention provides a mobile phone device with video output function. The mobile phone device comprises a mobile phone circuit and a video digital/analogue converter. The mobile phone circuit incorporates a digital camera capable of capturing a plurality of images. The video digital/analogue converter is coupled to the mobile phone circuit for converting the captured or stored digital images into analogue video output signals.

In one embodiment, the mobile phone circuit further comprises a radio frequency unit, a digital camera module, a memory card, a display unit and a base frequency processor. The radio frequency unit transmits and receives a radio frequency signal. The digital camera module executes all the functions necessary for capturing digital images. The memory card is a device for holding the captured images. The display unit displays the digital images. The base frequency processor is coupled to the radio frequency unit, the digital camera module, the memory card, the display unit and the video digital/analogue converter. The base frequency processor controls the transmission and reception of radio frequency signals, the storage of digital images, the display of images on the display unit and the output of analogue video signals from the video digital/analogue converter.

The display unit can be a liquid crystal display screen and the memory card can be a SD memory card, a MMC memory card, an XD memory card, a MS memory card or a mini-SD memory card. The analogue video signals from the video digital/analogue converter can be collected and displayed through a screen projector or a television set with a video input terminal.

In brief, this invention provides a mobile phone device with video output terminal that facilitates the transmission of digital images captured by the mobile phone device or digital images stored within a memory card to a screen projector or a television set.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a mobile phone device with video output function according to one preferred embodiment of this invention.

FIG. 2 is a diagram showing an application of the mobile phone device with video output function according to this invention.

FIG. 3 is a diagram showing another application of the mobile phone device with video output function according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

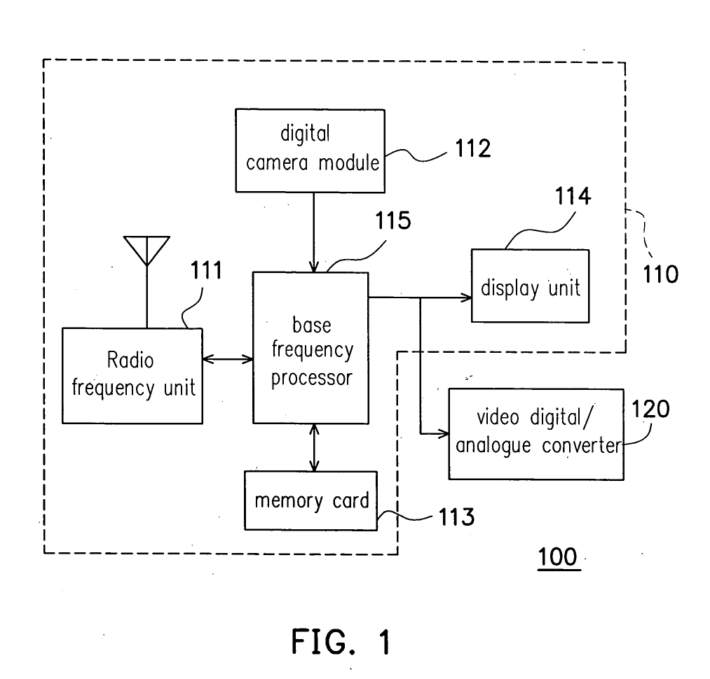

FIG. 1 is a block diagram of a mobile phone device with video output function according to one preferred embodiment of this invention. As shown in FIG. 1, the mobile phone device 100 comprises a mobile phone circuit 110 and a video digital/analogue converter 120. The mobile phone circuit 110 further includes a radio frequency unit 111, a digital camera module 112, a memory card 113, a display unit 114 and a base frequency processor 115. The base frequency processor 115 is coupled to the radio frequency unit 111, the digital camera module 112, the memory card 113, the display unit 114 and the video digital/analogue converter 120.

The base frequency processor 115, the radio frequency unit 111 and the display unit 114 such as a liquid crystal display screens together execute all the functions necessary to operate the mobile phone device. In other words, the base frequency processor 115 controls the transmission and reception of radio frequency signals to and from the radio frequency unit 111 and shows related messages on the display unit 114.

Because a digital camera is also incorporated into the mobile phone device 100, the base frequency processor 115, the digital camera module 112, the memory card 113 and the display unit 114 together execute all necessary functions for operating the digital camera. In other words, the base frequency processor 115 and the digital camera module 112 can be utilized to take pictures and produce digital images. The captured digital images are stored inside the memory card 113 or displayed on the display unit 114. Alternatively, the stored digital images are passed to the video digital/analogue converter and converted into analogue video signals. The analogue video signals are transmitted to a screen projector or a television set via a video output terminal in the mobile phone device so that the images are displayed on a screen projector or a television set.

The memory card 113 can be a SD memory card, a MMC memory card, an XD memory card, a MS memory card, a mini-SD memory card, for example.

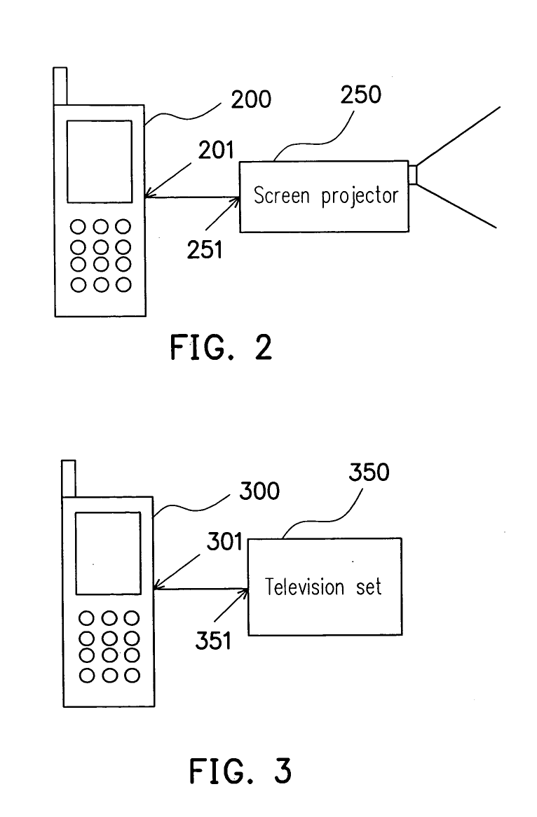

FIG. 2 is a diagram showing an application of the mobile phone device with video output function according to this invention. As shown in FIG. 2, a video output terminal 201 on a mobile phone device 200 and a video input terminal 251 on a screen projector 250 are connected together via a cable. Thus, the screen projector 250 can be used to display any stored digital images within the memory card (not shown) of the mobile phone device 200. For example, a company staff wishing to submit a short report with photos to a customer may organize the data and pictures using the PowerPoint software and subsequently converting the data into JPEG files for storage inside the memory card. Thereafter, the memory card is inserted into the mobile phone device 200 with video output function so that report data can be displayed on the screen projector 250. Since a mobile phone device is much easier to carry than a notebook computer, a brief business talk is more convenient to organize.

FIG. 3 is a diagram showing another application of the mobile phone device with video output function according to this invention. As shown in FIG. 3, a video output terminal 301 on a mobile phone device 300 and a video input terminal 351 on a television set 350 are connected together via a cable. Thus, the television set 350 can be used to display any stored digital images within the memory card (not shown) of the mobile phone device 300. For example, the mobile phone device 300 can be used to display captured digital images on television set 350 to friends or the family at home.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A mobile phone device with video output function, comprising:
a mobile phone circuit with digital camera function, for capturing a digital image; and
a video digital/analogue converter, coupled to the mobile phone circuit for converting the digital image into an analogue video output signal.

2. The mobile phone device of claim 1, wherein the mobile phone circuit comprises:
a radio frequency unit, for transmitting and receiving a radio frequency signal;
a digital camera module, for executing all the functions necessary for capturing the digital image;
a memory card, for holding digital images;
a display unit, for displaying the digital images; and
a base frequency processor, coupled to the radio frequency unit, the digital cameral module, the memory card, the display unit and the video digital/analogue converter for controlling the transmission and reception of radio frequency signals, the storage of digital images, the display of digital images and the output of analogue video signals from the video digital/analogue converter.

3. The mobile phone device of claim 2, wherein the display unit comprises a liquid crystal display screen.

4. The mobile phone device of claim 2, wherein the memory card comprises a SD memory card.

5. The mobile phone device of claim 2, wherein the memory card comprises a MMC memory card.

6. The mobile phone device of claim 2, wherein the memory card comprises a XD memory card.

7. The mobile phone device of claim 2, wherein the memory card comprises an MS memory card.

8. The mobile phone device of claim 2, wherein the memory card comprises a mini-SD memory card.

9. The mobile phone device of claim 1, wherein the analogue video signals can be display through a display device with a video input terminal.

10. The mobile phone device of claim 9, wherein the display device comprises a screen projector.

11. The mobile phone device of claim 9, wherein the display device comprises a television set.
